(19) United States
(12) Patent Application Publication
(10) Pub. No.: US 2010/0219644 A1
(43) Pub. Date: Sep. 2, 2010

(54) Power Generation using High Altitude Traction Rotors

(76) Inventor: Benjamin Tigner, Laguna Beach, CA (US)

Correspondence Address: FISH & ASSOCIATES, PC;ROBERT D. FISH, 2603 Main Street, Suite 1000, Irvine, CA, 92614-6232, US

(21) Appl. No.: 12/711,847

(22) Filed: Feb. 24, 2010

Related U.S. Application Data
(60) Provisional application No. 61/156,318, filed on Feb. 27, 2009.

(51) Int. Cl. F03D 9/00; F03D 5/00

(52) U.S. Cl. 290/55

(57) ABSTRACT

Power generation systems comprising an array of rotary-wing kites are presented. Rotary-wing kites can coupled to ground-based spools via tethers. As tension varies within the tethers, the spools wind and unwind. The rotational motion of the spools can be converted to electrical power via one or more generators.

This application claims the benefit of priority to U.S. provisional application having Ser. No. 61/156,318, filed on Feb. 27, 2009. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is aerial power generation technologies.

### BACKGROUND

The United States is beginning a transformation of its energy production and consumption infrastructure. Driven by US strategic interest in energy independence, diminishing global oil and gas reserves, and concerns about CO₂-induced climate change, this transformation seeks to develop renewable, carbon-free energy production technologies that depend only on domestic resources.

Scientists estimate that persistent winds in the troposphere carry several orders of magnitude more energy than the foreseeable needs of all mankind. But conventional wind turbines are unable to mine the heart of this resource because the bulk of the energy is carried in winds between three and six miles above the surface, well above the highest wind towers. Instead, a new class of tethered unmanned aircraft will be needed to extract this high altitude wind energy.

Several methods for deriving power from kites have been described in the literature. Two of these methods, lift power and drag power (see Loyd, M. L., Crosswind Kite Power, Journal of Energy, vol. 4, May-June 1980, p. 106-111), use fixed-wing kites flying nearly cross-ways to the wind and leverage the high flight speeds attainable in cross-wind flight to enhance the kite's potential for power extraction. The lift power method uses a kite's tether tension to do work on the tether's ground spool as the kite is blown downwind. In contrast, the drag power method harnesses the cross-wind component of the kite's lift, driving an onboard turbine or rotor rapidly through the air to generate electricity.

Several commercial systems are currently under development that use tethered aircraft to generate power from wind, but each has disadvantages. Some of these systems (see www.kitegen.com for example) use light-weight fixed-wing fabric kites similar to those used in kite-boarding to generate power on the ground using a lift-power method. Though these kites are inexpensive compared with other unmanned aircraft, they are aerodynamically inefficient, need frequent replacement or maintenance, and require significant manpower to operate. These systems must attain high cross-wind speeds to be effective, and it can be shown that most of the power extracted by the kite is expended pulling the kite's tether through the air. Other systems (see www.skywindpower.com) use autorotating quad-rotor helicopters that generate electricity onboard the aircraft and transmit the power to the ground on conductors in the tether. These systems employ a variation of the drag-power method, where the rotor blades are equivalent to kites traveling in a circular cross-wind pattern. The cross-wind component of the lift on the rotor blades produces the shaft torque to turn the generators. These systems solve the tether-drag problem associated with fixed-wing lift-power kites by allowing the tether to remain stationary while the rotor blades travel rapidly through the air. But the quad-rotor machines will be expensive to build and maintain because of the complex onboard systems needed to control the four rotors and convert the mechanical shaft power to electricity. Their tethers will be expensive due to the combined requirement for strength and conductivity, and these systems need to generate very high voltages minimize the power losses on the tether. Other systems have also been proposed or are in development, but are less relevant to the inventive subject matter (see http://peswiki.com/index.php/Directory:High_Altitude_Wind_Power for a summary of proposed methods).

Yet other systems include those disclosed in Great Britain patent application publication GB 2 441 924 to Rolt titled “Wind Driven Power Generation”, filed Feb. 14, 2005; U.S. Pat. No. 4,450,364 to Benoìt titled “Lighter Than Air Wind Energy Conversion System Utilizing a Rotating Envelope”, filed Mar. 24, 1982; U.S. Pat. No. 6,254,034 to Carpenter titled “Tethered Aircraft System for Gathering Energy from Wind”, filed Sep. 20, 1999; U.S. Pat. No. 6,923,622 to Dehlsen titled “Mechanism for Extendable Rotor Blades for Power Generating Wind and Ocean Current Turbines and Means for Counter-Balancing the Extendable Rotor Blade” filed Jan. 15, 2003; U.S. Pat. No. 7,317,261 also to Rolt titled “Power Generating Apparatus”, filed Jul. 25, 2006; and International patent application publication WO 92/20917 titled “Free Rotor”. Unfortunately, many of these systems also suffer from one or more of the above described deficiencies, not the least of which is undesirable tether movement.

Thus, there remains a need for systems that avoid the tether drag problem of fixed-wing lift-power systems and the expense and complexity of rotary-wing drag-power systems.

### SUMMARY OF THE INVENTION

The inventive subject matter provides apparatus, systems and methods in which power can be generated from wind through the use of multiple rotary-wing kites. One aspect of the inventive subject matter includes a system having a plurality of rotary-wing kites, possibly traction rotors, where each kite is coupled to a spool via a tether. The spools can couple to one or more generators. The generators can derive power from motions of the spools in response to downwind and upwind motions of the rotary-wing kites. The kites can be deployed at altitudes greater than 5,000; 10,000; or even 20,000 feet above sea level.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 presents a schematic overview of a possible rotary-wing kite power generation system and a detail image of a rotary-wing—spool arrangement.

FIG. 2 illustrates various possible rotary-wing kite configurations.

### DETAILED DESCRIPTION

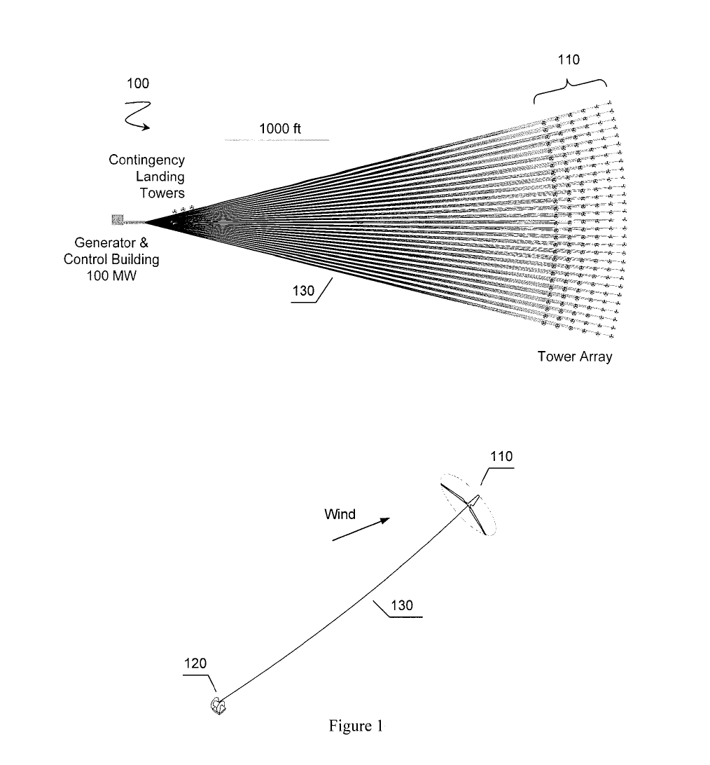

FIG. 1 presents an overview of power generation system 100 comprising multiple rotary-wing kites 110 coupled to generator station 140 via tethers 130. Preferably, tethers 130 each couple to spool 120 as shown in the detail drawing. As the wind blows, as indicated, rotary-wing kites 110 ascend, possibly from a tower, causing tension to increase on tether 130.

In a preferred embodiment, rotary-wing kites 110 comprise traction rotors. A traction rotor is a rotary-wing lift-power kite, using the power of the wind to spin its rotor, maintain altitude, and deliver mechanical power to the ground through tension forces on its tether 130. Power can be produced in a reciprocating manner, with a downwind power stroke followed by an upwind return stroke. During the downwind stroke, rotor 110 creates large tension forces on its tether 130 and does work by unwinding spool 120 on the ground as the rotor blows downwind. Rotor 110 then returns upwind, minimizing tether tension on tether 130 as spool 120 winds back in. The optimum power cycle preferably consists of a series of operating conditions that maximize the difference between the power delivered during the power stroke and the power absorbed during the return stroke. The net power delivered by a single rotor 110 is combined with power from other rotors 110 in large arrays to produce a smooth continuous electric power supply. Utility-scale rotor arrays that use a single large generator benefit from economies of scale in generators: large electrical generators are less expensive than multiple small generators of the same total capacity. It is also contemplated that an array of smaller generators 140 could couple to spools 120.

Systems employing traction rotors are considered superior to other fixed-wing lift-power systems because tether 130 remains approximately stationary in space and minimize power lost due to tether drag. Systems employing traction rotors are also considered superior to known rotary-wing drag-power systems because of the simplicity of the aircraft and tether arrangement. The high control authority afforded by a single rotor supports simpler, more automated operation than other known wing-base systems. Furthermore, the contemplated system provides for a higher density of rotors than systems that allows for large circular or lateral movement of tethers.

A detailed cost and power analysis has been performed for an array of 170 traction rotors, each with a rotor diameter of 40 ft, coupled through their ground spools with a 100 MW ground generator. If the kites are operated at an altitude of 25,000 ft, the analysis indicates that such an array could produce 245 million kWHr annually at a cost of less than 4.0 ¢/kWHr. Contemplated systems can be configured to operate kites 110 at an altitude of at least 5,000; 10,000; 20,000; or even 25,000 ft above sea level.

Tethers 130 are preferably light weight, yet strong. In some embodiments, tethers 130 can comprise cables, possibly formed from carbon fiber or composites. Preferably tethers 130 can withstand more than 5,000; 10,000; or 20,000 lbs of tension.

An alternative method of power generation is also contemplated, whereby the mechanical power of one or more traction rotors is used to pump water from the outlet of a pre-existing hydro-electric plant back into the plant's upstream reservoir. If the plant's generating capacity is underutilized due to lack of water flow, then the traction-rotor's effect will be to increase the available flow, boosting the plant's capacity factor. Benefits of this symbiosis between high-altitude wind and hydro power can include (1) persistent energy storage for the power delivered by the traction rotors, (2) more efficient utilization of the investment in hydro-power generating capacity, (3) access to the existing hydro-electric facility's grid connection infrastructure, and (4) effectively unlimited power absorption capability for the traction rotors during periods of peak winds. The symbiosis between traction rotors and existing hydro-electric infrastructure is expected to enable power production at costs less than 2.0 ¢/kWHr.

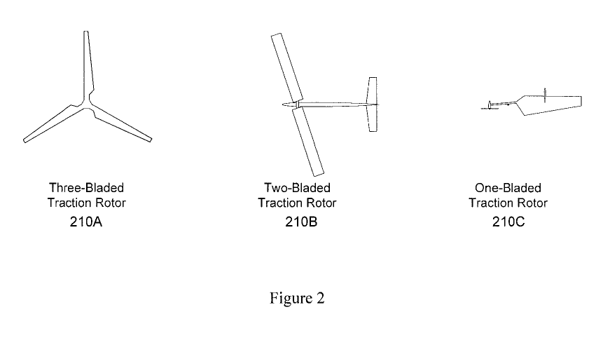

FIG. 2 illustrates a few of the many possible different configurations of rotors for a tension rotor. It is contemplated that traction rotors can be implemented using one, two, three, or more lifting blades as illustrated in rotors 210A, 210B, and 210C. Asymmetric single-bladed rotor 210C, like maple seeds, offer some advantages as their natural asymmetry lends itself to variable cone angle and variable rotor diameter, both of which may be useful in the operation of traction rotor power systems.

In some embodiments, traction rotors comprise additional capabilities beyond mere rotation. For example, rotors can include a pitch controller that adjusts pitch of the rotor blades. Pitch adjustment can be controlled via the rotors tether or through wireless communications, if desired. Adjusting blade pitch can increase efficiency of a rotor in variable wind conditions, or can be used to adjust tether tension for greater efficiency in power or return strokes for power generation.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A wind based energy generating system, comprising:
a first rotary-wing kite operatively coupled by a first tether to a first ground spool;
a second rotary-wing kite operatively coupled by a second tether to a second ground spool; and
a generator configured to derive power from motions of the first and second ground spools.

2. The system of claim 1, wherein the first rotary-wing kite has a rotor diameter of at least 5 m.

3. The system of claim 1, wherein the first rotary-wing kite has a rotor diameter of at least 10 m.

4. The system of claim 1, wherein the first rotary-wing kite has a single-bladed rotor.

5. The system of claim 1, wherein the first rotary-wing kite as two or more rotor blades.

6. The system of claim 1, wherein the first tether and first spool are configured to generate power by operating the first rotary-wing kite at more than 10,000 ft above sea level.

7. The system of claim 6, wherein the first tether and first spool are configured to generate power by operating the first rotary-wing kite at more than 20,000 ft above sea level.

8. The system of claim 1, wherein the first tether is configured to withstand at least 5,000 lb of tension.

9. The system of claim 8, wherein the first tether is configured to withstand at least 10,000 lb of tension.

10. The system of claim 9, wherein the first tether is configured to withstand at least 20,000 lb of tension.

11. The system of claim 1, wherein the first rotary-wing kit comprises a traction rotor, and is disposed at an existing hydro-electric facility and configured to pump water upstream.

12. The system of claim 1, wherein generator comprises an array of electrical generators coupled to the first and the second spools.

13. The system of claim 1, wherein the generator is configured to derive power via a repeating cycle of a downwind and an upwind stroke in response to movement of the first rotary-wing kit.
